(19) United States
(12) Patent Application Publication
(10) Pub. No.: US 2004/0035395 A1
(43) Pub. Date: Feb. 26, 2004

(54) Hydrogen and carbon monoxide enhanced knock resistance in spark ignition gasoline engines

(76) Inventors: John B. Heywood, Newston, MA (US); Leslie Bromberg, Sharon, MA (US); Alexander Rabinovich, Swampscott, MA (US); Daniel R. Cohn, Chestnut Hill, MA (US); Jennifer Topinka, Pittsville, WI (US)

Correspondence Address: Sam Pasternack, Esq., Choate, Hall & Stewart, Exchange Place, 53 State Street, Boston, MA, 02109, US

(21) Appl. No.: 10/460,574

(22) Filed: Jun. 12, 2003

Related U.S. Application Data
(63) Continuation-in-part of application No. 09/990,910, filed on Nov. 14, 2001, now Pat. No. 6,655,324.

(51) Int. Cl. F02M 25/10; F02M 25/14

(52) U.S. Cl. 123/435; 123/198 A

(57) ABSTRACT

A method for reducing required octane number and a spark ignition gasoline engine system with hydrogen-enhanced knock resistance. The method for reducing required octane number of gasoline needed to prevent knock includes the addition of hydrogen or hydrogen-rich gas containing carbon monoxide to gasoline. Octane number can be improved by 5 or more for a hydrogen energy fraction of 10%. The spark ignition gasoline engine system includes a spark ignition gasoline engine and a source of gasoline and hydrogen or hydrogen-rich gas. Apparatus is provided to supply the gasoline and the hydrogen or hydrogen-rich gas to the engine at a varying hydrogen or hydrogen-rich gas to gasoline ratio selected both to prevent knock and to ensure a desired level of combustion stability throughout a full range of engine operation. The engine system may be normally aspirated or boosted; the compression ratio may be high such as greater than 11 or below 11, and EGR may be added. The hydrogen or hydrogen-rich gas to gasoline ratio may be controlled as a function of boost pressure, torque, engine speed, or air/fuel mixture ratio.

This application is a continuation-in-part of U.S. patent application Ser. No. 09/990,910 filed Nov. 14, 2001, entitled “High Compression Ratio Hydrogen-Enhanced Gasoline Engine System”, the contents of which are incorporated herein by reference.

### BACKGROUND OF THE INVENTION

This invention relates to spark ignition gasoline engines, and more particularly, to enhancing knock resistance of such engines.

Engine knock can prevent the use of high compression ratio operation in a spark ignition gasoline engine. Typically, spark ignition gasoline engines are limited to a compression ratio of less than 10.5. Knock is the undesired auto-ignition of unburned fuel and air before it can be burned by the expanding flame front in a spark ignition engine and is exacerbated by high compression ratio operation. Knock at a high compression ratio could be avoided by employing lean operation or dilution from Exhaust Gas Recirculation (EGR). However, the fuel dilution from lean or EGR operation will reduce engine power density (power/cylinder volume).

Pressure boosting can in principle compensate for the adverse effect of dilution upon engine power density. Boosting is accomplished by turbocharging or supercharging. In fact, under appropriate conditions, sufficiently high boosting can be used to more than compensate for the effect of dilution and thus increase engine power density to a level greater than that at stoichiometric operation. The higher engine power density can allow downsizing of the engine thereby providing a significant additional improvement in efficiency.

However, achieving high compression ratio operation without reducing engine power density is impeded because boosting also promotes engine knock. The present patent application discloses and claims novel approaches to maximize the engine power density in high compression ratio spark ignition gasoline engines using both boosted and non-boosted operation. This application also discloses and claims novel approaches to enhance knock resistance in spark ignition gasoline engines.

### SUMMARY OF THE INVENTION

According to one aspect, the invention is a method for reducing the required octane number of gasoline needed to prevent knock comprising the addition of hydrogen to the gasoline. In another aspect, this method for reducing the required octane number comprises the addition of carbon monoxide to gasoline. In still another aspect, the method for reducing the required octane number of gasoline includes the addition of hydrogen and carbon monoxide to the gasoline. In a preferred embodiment of this aspect of the invention, a hydrogen/gasoline ratio is selected to reduce the required octane number by 5 or more for a hydrogen energy fraction of 10%. Alternatively, the carbon monoxide/gasoline ratio is selected to reduce the required octane number by 5 or more for a carbon monoxide energy fraction of 15%.

In another aspect, the invention is a spark ignition gasoline engine system including a spark ignition gasoline engine and a source of gasoline and hydrogen. Apparatus is provided to supply the gasoline and hydrogen to the engine at a varying hydrogen/gasoline ratio selected both to prevent knock and to ensure a desired level of combustion stability throughout a full range of engine operation. In another aspect, the invention is a spark ignition gasoline engine system including a gasoline engine along with a source of gasoline and hydrogen-rich gas. Apparatus is provided to supply the gasoline and the hydrogen-rich gas to the engine at a varying hydrogen-rich gas/gasoline ratio selected both to prevent knock and to ensure a desired level of combustion stability throughout a full range of engine operation. In a preferred embodiment of this aspect of the invention, the hydrogen-rich gas includes carbon monoxide. In a preferred embodiment, the engine operates at a compression ratio of 11 or higher. In another preferred embodiment, the engine system further includes apparatus to boost air pressure introduced into the engine such as a turbo charger or supercharger.

In yet another preferred embodiment, the engine system is operated such that above a selected boost pressure or torque, the hydrogen/gasoline ratio is greater than that required for combustion stability and is determined by the requirement to avoid knock. The hydrogen/gasoline ratio or the hydrogen-rich gas/gasoline ratio may be selected to prevent knock and is varied as a function both of engine speed and boost pressure or torque. The engine system may be operated such that the hydrogen/gasoline ratio decreases above a characteristic level of engine power.

A suitable hydrogen/gasoline ratio for the engine system of the invention may be determined by measuring boost pressure or torque above a selected boost pressure or torque. An on-board knock sensor is provided in one embodiment to select the hydrogen/gasoline ratio to prevent knock.

In yet another preferred embodiment, EGR is supplied to the engine and EGR may be added or increased when the engine is operated above a selected level of boost or torque. In yet another embodiment of this aspect of the invention, apparatus provides a desired spark retard above a selected boost pressure or torque to increase knock resistance and the hydrogen/gasoline ratio is sufficient to allow greater spark retard than would be possible without hydrogen addition.

The hydrogen and/or hydrogen-rich gas may be provided by an on-board reformer such as a plasmatron reformer or it may be stored on-board.

### BRIEF DESCRIPTION OF THE DRAWING

FIGS. 1-4 are graphs of octane number requirement (ONR) decrease as a function of added energy from hydrogen and carbon monoxide.

FIG. 5 is a block diagram of a hydrogen-enhanced spark ignition gasoline engine system according to an embodiment of the invention.

FIG. 6 is a graph of hydrogen/gasoline ratio required to prevent knock as a function of engine speed for two different pressures.

FIG. 7 is a graph of hydrogen/gasoline ratio required to prevent knock as a function of engine speed for two different torques.

### DESCRIPTION OF THE PREFERRED EMBODIMENT

We have recently carried out experiments at the Massachusetts Institute of Technology to determine the impact of various parameters upon knock in spark ignition gasoline engines. These experiments have shown that the addition of hydrogen has a surprisingly substantial effect on increasing the knock resistance of gasoline. Specifically, the experiments studied the effects of hydrogen and hydrogen-rich gas containing carbon monoxide on octane number requirement. The octane number of a fuel represents its ability to resist knock. The typical difference in octane number between regular and premium grade gasoline is ˜6.

Experiments to identify the knock trends of mixtures enhanced with hydrogen (H₂) and carbon monoxide (CO) were performed on a single cylinder research spark ignition engine with boosting capability. The experimental method used to investigate knock trends consisted of determining the octane number of gasoline supplied to the engine that results in audible knock. This number is defined as the octane number requirement (ONR). All tests were completed at 1500 rpm, maximum brake torque (MBT) spark timing, with coolant temperature at fully warmed-up conditions and intake air temperature at 20° C. Gasoline-only knock investigations were performed and selected tests were then repeated with H₂ and CO enhancement. The experiments used bottled gas to study the effects of hydrogen and hydrogen-rich gas, such as that produced by conversion of gasoline in a plasmatron reformer. The added mixture simulated that expected from 15% and 30% of the gasoline mass being reformed in a plasmatron reformer.

These experiments showed that a modest amount of hydrogen could significantly increase the octane number of a gasoline-hydrogen mixture. Said another way, the addition of hydrogen (or hydrogen-rich gas) reduces the required octane number of the gasoline itself so that a less expensive grade of gasoline can be used with an acceptable level of knock resistance because of the addition of hydrogen. The hydrogen or hydrogen-rich gas can thus replace a portion of the gasoline. An addition of hydrogen (or hydrogen-rich gas) representing 10% of the energy of the hydrogen-gasoline fuel mixture increases the octane number by between 5 and 10. Even more surprising, carbon monoxide also significantly increases the fuel octane number.

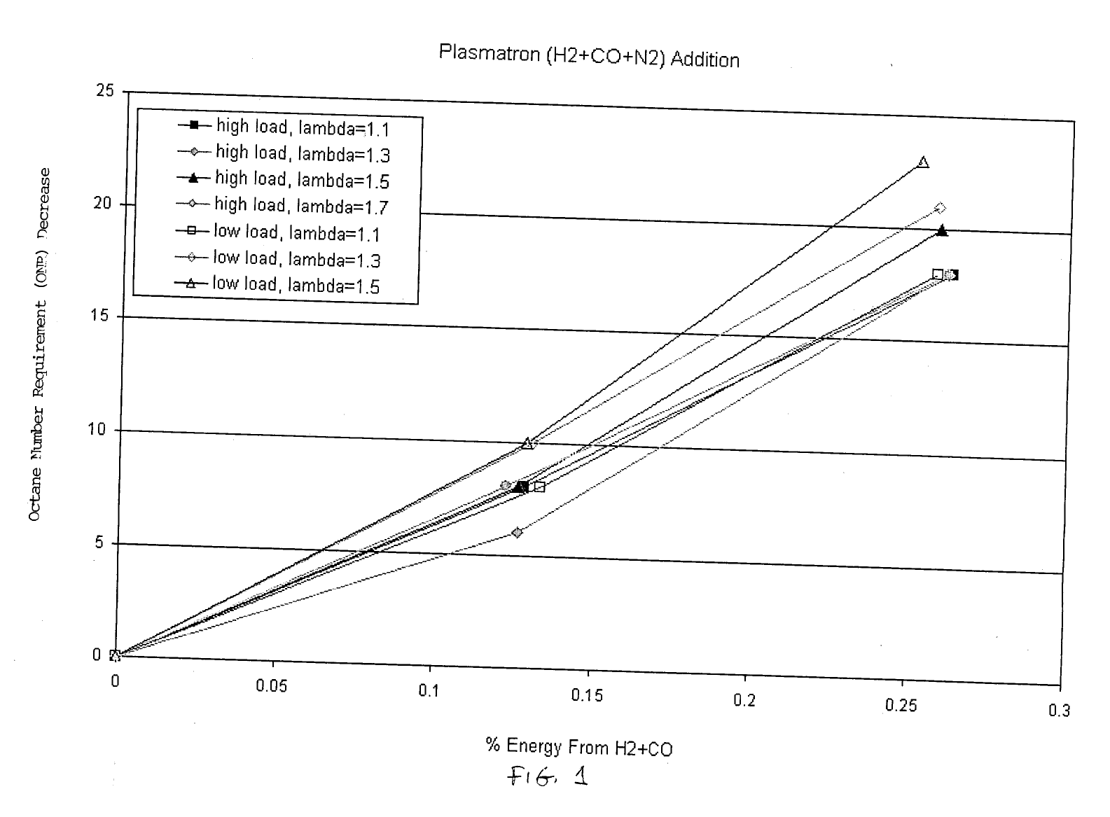

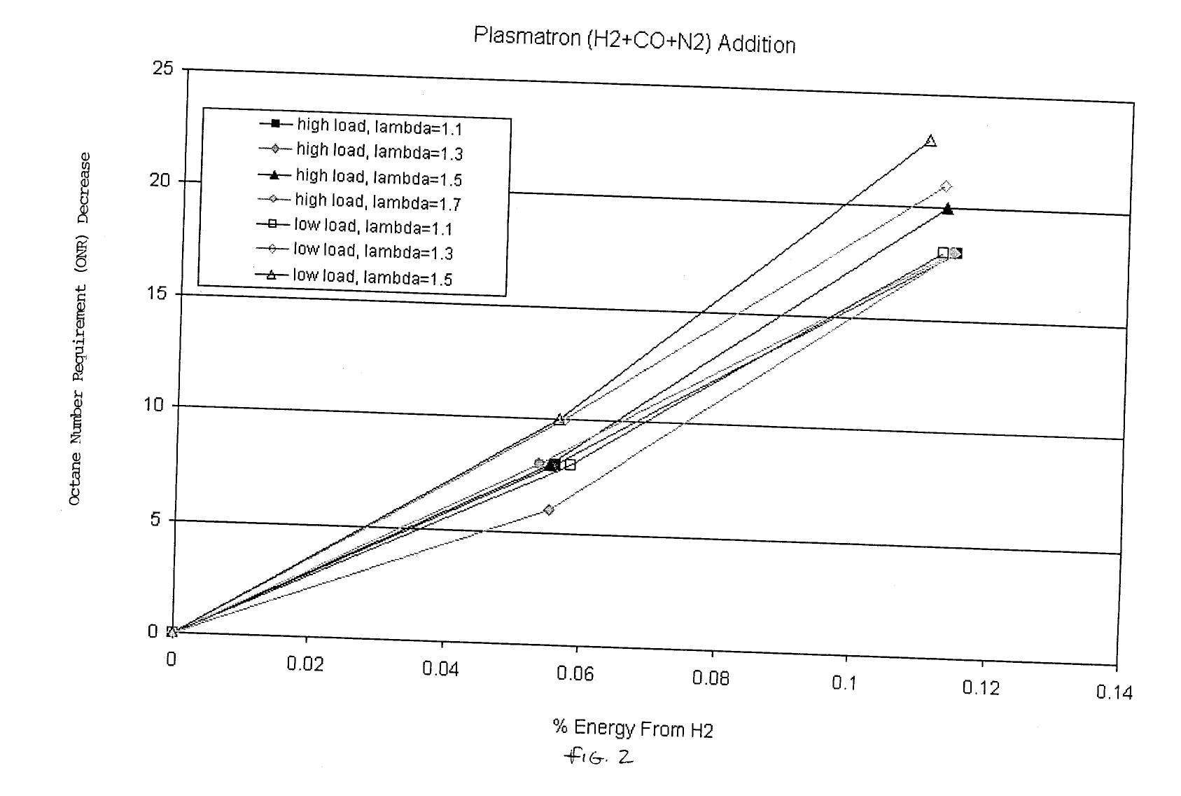

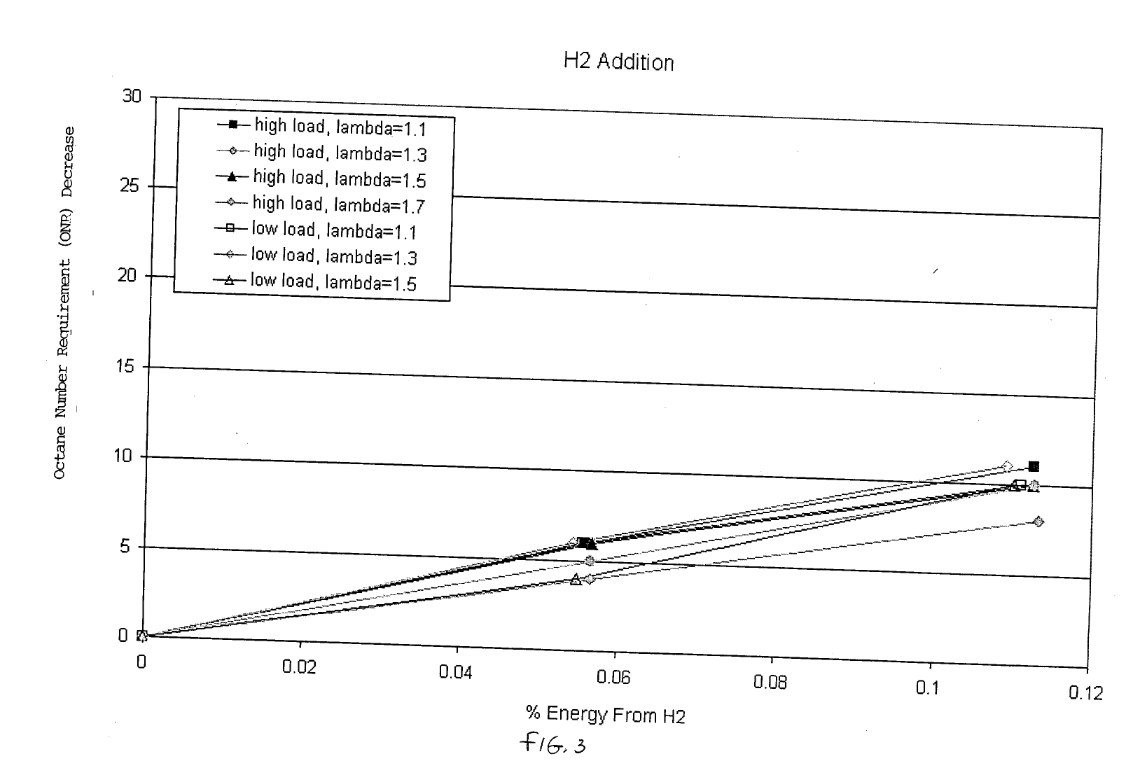

The decrease in gasoline octane number that could be achieved without knock was determined as a function of the amount of hydrogen and hydrogen-rich gas addition. Data that show octane number requirement (ONR) reduction as a function of additive energy content are shown in FIGS. 1-4. Lambda (λ) is the ratio of the actual air/fuel ratio to the stoichiometric air/fuel ratio. While results are shown for λ greater than one, similar trends were observed for stoichiometric and slightly rich operation. The effect of carbon monoxide is inferred from the effects of hydrogen and hydrogen-rich gas as shown in FIG. 4. With hydrogen-rich gas representing 25% of the total fuel energy content, the octane number of the total fuel is raised by about 20 since the gasoline octane number can be reduced by about that amount as shown in FIG. 1. This increase is about three times the increase in going from regular to premium grade gasoline. Such an increase allows the compression ratio to be increased by between 3 and 6 with other parameters held fixed.

These results establish that both hydrogen and carbon monoxide are powerful octane enhancers, alone or in combination, in analogy with the previous use, before discontinuation because of environmental regulations, of tetraethyl lead. Moreover, there was no evidence of a propensity for pre-ignition as in the case with use of pure hydrogen in an internal combustion engine. To the inventors' knowledge, neither hydrogen nor carbon monoxide has been previously investigated as a means to enhance octane in a spark ignition gasoline engine.

The present invention also includes the variable addition of hydrogen or hydrogen-rich gas (principally hydrogen and carbon monoxide) to provide an on-demand increase in gasoline octane number to prevent knock. Hydrogen addition is also used to increase the gasoline octane number during periods of boosting when knock would otherwise be present. The invention also includes the use of hydrogen to increase knock resistance when the engine operating conditions are changed through increased use of EGR or by employing greater spark retard.

The amount of hydrogen addition throughout the full range of engine operation is selected to be sufficient to meet combustion stability goals in addition to preventing knock. For example, when lean operation of hydrogen enhanced spark ignition gasoline engines is utilized, it is desirable that engine out NOₓ be suppressed to sufficiently low values to meet the most stringent anticipated requirements for vehicle pollution reduction with minimal or no need for further reduction by lean exhaust aftertreatment. Substantial NOₓ reduction by exhaust aftertreatment in a lean environment can be difficult and costly. Stratified hydrogen injection can be used to improve the effectiveness of hydrogen for combustion stability and knock resistance. The hydrogen/gasoline ratio employed is a particularly important parameter; reduction of the hydrogen/gasoline ratio decreases the power loss resulting from reforming of gasoline into hydrogen-rich gas.

Boosting shifts the lean combustion stability limit to higher values of λ, as described by J. Stokes et al., SAE paper 2000-01-2902, the contents of which are incorporated herein by reference. The hydrogen/gasoline ratio required to achieve combustion stability at a given value of λ is thus reduced with boosting. In order to benefit from this effect, a control system decreases the hydrogen/gasoline ratio as boost pressure increases.

However, the control strategy will change if, in addition to its use to enhance combustion stability and thereby to allow more dilute operation, hydrogen or hydrogen-rich gas is also employed to improve knock resistance; the improved knock resistance will allow higher boosting levels and/or use of higher compression ratio. In order to obtain the most useful combination of boost pressure, potential for engine downsizing and high compression ratio, it may thus be useful to operate with a higher value of the hydrogen/gasoline ratio than is required for lean burn or enhanced EGR combustion stability alone.

When the boosting level is sufficiently high that the required hydrogen/gasoline ratio is determined by knock resistance, the required hydrogen/gasoline ratio will increase with increasing boost pressure. The use of an increased hydrogen/gasoline ratio thus essentially serves as a means of on-demand gasoline octane number enhancement.

A control system disclosed herein to take advantage of this benefit varies the hydrogen/gasoline ratio during the full range of engine operation. The required hydrogen/gasoline ratio at each value of boost pressure is determined by which one of the requirements of combustion stability or knock resistance calls for the highest ratio. It is desirable that the ratio be minimized at various points in the drive cycle. This minimization is accomplished by requiring that the ratio be lower than a predetermined value at each point while still meeting combustion stability and knock resistance requirements.

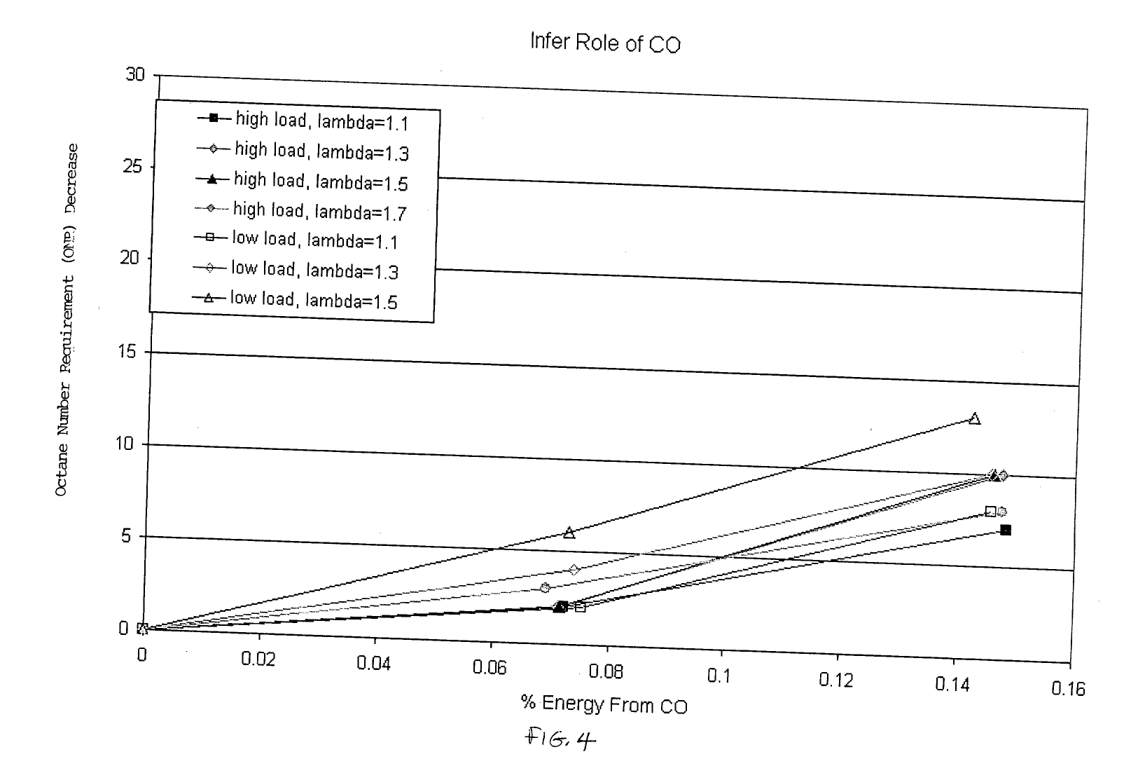

An illustrative control system is shown in FIG. 5. Hydrogen-rich gas 10 is provided by a plasmatron reformer 12. The hydrogen-rich gas 10 is introduced into a spark ignition gasoline engine 14 along with gasoline 16 from a fuel tank 18. The fuel tank 18 also supplies gasoline 16 to the plasmatron reformer 12. A compressor 20 compresses air for delivery to the engine 14 and also, if desired, to the plasmatron reformer 12. The compressor 20 includes a pressure sensor (not shown) to deliver a pressure sensor signal 22 to a control system 24. Similarly, the engine 14 includes a knock sensor (not shown) to deliver a knock sensor signal 26 to the control system 24. In this embodiment, the control system 24 controls the flow of gasoline 16 into the engine 14 and also controls the fraction of gasoline that is reformed in the plasmatron reformer 12 so as to control the amount of hydrogen-rich gas delivered to the engine 14. The control system 24 thus controls the hydrogen-rich gas/gasoline ratio along with other engine parameters. The hydrogen/gasoline ratio at various points in the engine drive cycle is therefore determined by the boost pressure and/or the detection of knock. In addition to preventing knock, it is required that combustion stability be achieved throughout the engine operating range.

The presence of knock depends upon engine speed and spark timing as well as torque (see J. B. Heywood, Internal Combustion Engine Fundamentals, McGraw-Hill, New York, 1988, p. 853, the contents of which are incorporated herein by reference). Hence, it may be useful to vary the hydrogen/gasoline ratio used for knock avoidance as a function of engine speed at a given boost pressure. Engine power is the product of torque, which can depend upon boost pressure, and speed. Under most circumstances, the maximum knock resistance will be required at engine speed/boost points which correspond to engine power levels that are significantly lower than the maximum engine power. Maximum knock resistance may be required at the highest value of torque but at a speed which is significantly less than the maximum engine speed.

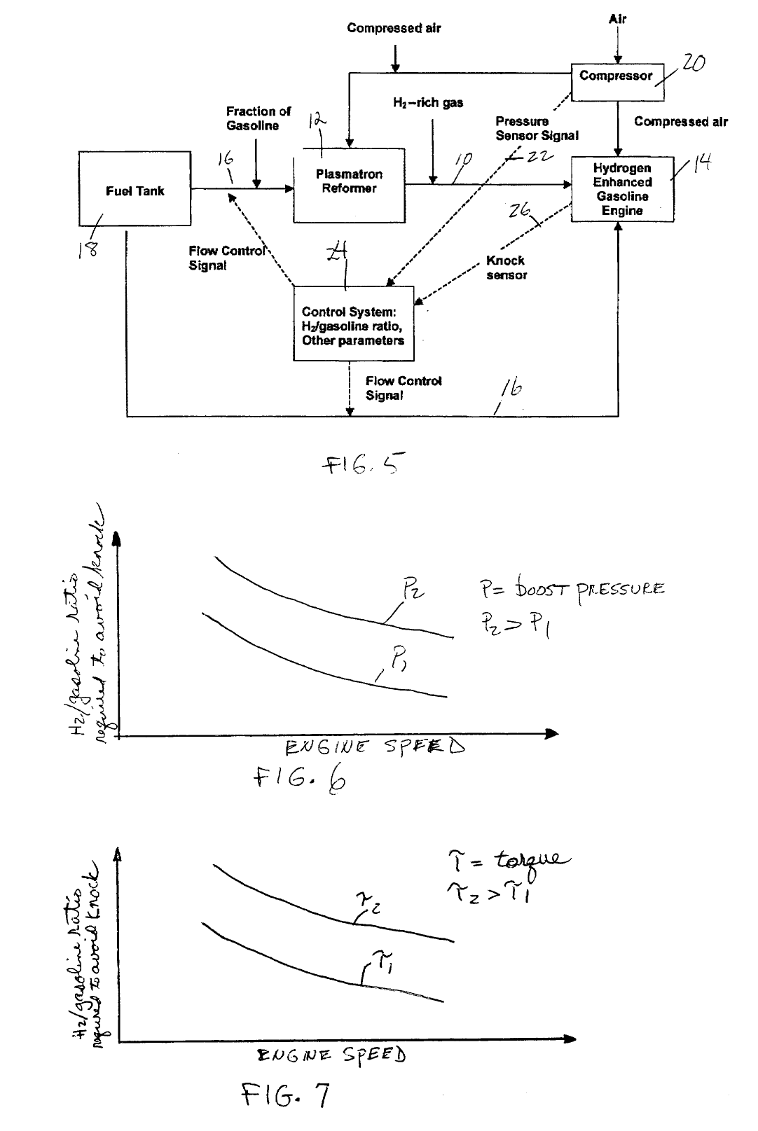

By varying the hydrogen/gasoline ratio used to achieve knock resistant operation as a function of engine speed as well as boost pressure, it is possible and desirable to lower the required hydrogen/gasoline ratio at maximum engine power and gasoline flow rate. Since the hydrogen flow requirement is equal to the product of the hydrogen/gasoline ratio and the gasoline flow rate, reducing the hydrogen/gasoline ratio will lower the maximum hydrogen flow requirement and minimize the throughput requirement for an onboard reformer. FIGS. 6 and 7 illustrate how the hydrogen/gasoline ratio required to prevent knock varies for engine speed at different boost pressures and at different torque levels. The curves in FIGS. 6 and 7 thus are used by the control system 24 of FIG. 5 to minimize the amount of hydrogen that must be generated by the plasmatron reformer 12.

The system disclosed herein for controlling the hydrogen/gasoline ratio as a function of boost pressure can be applied to hydrogen enhanced spark ignition gasoline engines with stored hydrogen as well as to engines using hydrogen and carbon monoxide from an onboard reformer, such as the plasmatron reformer 12 shown in FIG. 5. A gasoline engine vehicle using stored hydrogen might use the hydrogen only during brief periods of high boost pressure in order to prevent knock. The hydrogen would not be used to extend the lean limit; the air/fuel mixture of the engine would be stoichiometric in this case. The benefit of using the hydrogen in this manner would be to obtain significantly higher power density and thus to facilitate engine downsizing, which would lead to higher efficiency or to allow for use of a higher compression ratio. Since the hydrogen would be used only a small fraction of the time and would be used as an additive, hydrogen storage requirements would be minimal while at the same time the hydrogen addition would have an important effect on engine efficiency. Exhaust Gas Recirculation (EGR) may be used in conjunction with the stoichiometric operation.

This type of stoichiometric operation can also be employed with an onboard reformer. If the gasoline reformation occurs only for relatively short periods of time at significant boost pressures, reformer losses would have a minimal effect on overall system efficiency while facilitating higher boost pressures and/or allowing for higher compression ratio operation. A variation of this approach would be to reform at least a small fraction of the gasoline at all times in the drive cycle in order to facilitate the best transient reformer performance and always provide some combustion stability improvement by always adding some hydrogen-rich gas.

Another mode of operation contemplated herein is to use cooled EGR with stoichiometric or fuel rich, i.e., λ greater than one, operation at high loads. Use of cooled EGR at high loads facilitates higher engine power density operation.

It is thus contemplated by the inventors to use hydrogen addition to extend the EGR limit as well as to directly reduce the octane requirement. In this mode of operation both hydrogen and the EGR level is increased with boost pressure. The EGR level selected could be the maximum allowed by addition of hydrogen without adversely affecting combustion stability. Cooling of the recirculated exhaust gas is desirable to minimize the adverse effect of the elevated temperature of the exhaust upon knock resistance.

With stoichiometric operation throughout the drive cycle, a 3-way catalyst plus EGR can be used, thereby insuring suppression of NOₓ to extremely low levels. Hydrogen enhanced EGR is optional at lower loads.

Maximum efficiency is obtained by using lean operation plus some cooled EGR at lower loads. The lean operation can minimize pumping losses and maximize thermodynamic efficiency through a favorable ratio of specific heats. The presence of some EGR could facilitate the transition to stoichiometric and EGR operation at high loads.

The combination of hydrogen or hydrogen-rich gas octane number enhancement and an increase in knock resistance from hydrogen enhanced cooled EGR could allow high power density, high compression ratio operation with significant downsizing capability, and NOₓ reduced to extremely low levels. The NOₓ reduction would be achieved by the use of a three-way catalyst at stoichiometric operation along with the effect of EGR. In contrast to boosting under lean conditions, dilution will be relatively low and high engine power density can be obtained with relatively moderate boost pressures. Further capability for high power density and high compression ratio operation can be obtained by use of direct injection.

It is also contemplated that lean operation can be employed at all loads with hydrogen or hydrogen-rich gas used to increase knock resistance by increasing the octane number and to facilitate boosted operation and higher power engine density at high loads.

It is well established that spark retard enhances gasoline engine knock resistance. Hydrogen enhanced combustion stability allows for greater spark retard when spark retard is used at higher values of torque and boost pressure to reduce knock. Increased spark retard further increases knock resistance.

These approaches for varying the hydrogen/gasoline ratio to meet combustion stability and knock resistance requirements can be used in boosted engines with standard compression ratios (compression ratio ≦10) as well as in high compression ratio engines, although high compression ratio improves efficiency.

These approaches can also be used to prevent knock and increase the allowed compression ratio in engines which do not use boosting. In this case the hydrogen/gasoline ratio would be varied as a function of engine torque. Control based upon engine torque can also be used in the case of a boosted engine.

In the case of control based on engine torque the hydrogen/gasoline ratio as a function of torque is varied according to the propensity of knock at a given engine speed. As is the case with the variation with boost pressure, the hydrogen/gasoline ratio can be reduced at higher speeds, thereby reducing the maximum amount of hydrogen that would be produced by an onboard reformer. The approach is illustrated in FIGS. 6 and 7 which show the hydrogen/gasoline ratio needed to prevent knock decreasing with increasing engine speed.

For engine systems using onboard reforming, the fraction of gasoline sent to the reformer is varied instead of the hydrogen/gasoline ratio directly. The above control features can also be used in spark ignition engines employing ethanol, methanol, natural gas and propane.

What is claimed is:

1. Method for reducing required octane number of gasoline needed to prevent knock in a spark ignition engine comprising addition of hydrogen to the gasoline.

2. Method for reducing required octane number of gasoline needed to prevent knock in a spark ignition engine comprising addition of carbon monoxide to the gasoline.

3. Method for reducing required octane number of gasoline needed to prevent knock in a spark ignition engine comprising addition of hydrogen and carbon monoxide to the gasoline.

4. Spark ignition gasoline engine system comprising:
a spark ignition gasoline engine;
a source of gasoline and hydrogen; and
apparatus to supply the gasoline and the hydrogen to the engine at a varying hydrogen/gasoline ratio selected both to prevent knock and to ensure a desired level of combustion stability throughout a full range of engine operation.

5. Spark ignition gasoline engine system comprising:
a spark ignition gasoline engine;
a source of gasoline and hydrogen-rich gas; and
apparatus to supply the gasoline and the hydrogen-rich gas to the engine at a varying hydrogen-rich gas/gasoline ratio selected both to prevent knock and to ensure a desired level of combustion stability throughout a full range of engine operation.

6. The engine system of claim 5 wherein the hydrogen-rich gas includes carbon monoxide.

7. The method of claim 1 wherein a hydrogen/gasoline ratio is selected to improve octane number by 5 or more for a hydrogen energy fraction of 10%.

8. The method of claim 2 wherein a carbon monoxide/gasoline ratio is selected to improve octane number by 5 or more for a carbon monoxide energy fraction of 15%.

9. The engine system of claims 4, 5, or 6 wherein the engine operates at a compression ratio of 11 or higher.

10. The engine system of claims 4, 5, or 6 further including apparatus to boost air pressure introduced into the engine.

11. The engine system of claim 10 wherein the apparatus to boost air pressure is a turbocharger.

12. The engine system of claim 10 wherein the apparatus to boost air pressure is a supercharger.

13. The engine system of claim 10 wherein above a selected boost pressure or torque the hydrogen/gasoline ratio is greater than that required for combustion stability and is determined by a requirement to avoid knock.

14. The engine system of claims 4, 5, or 6 wherein the hydrogen/gasoline ratio or the hydrogen-rich gas/gasoline ratio is selected to prevent knock and is varied as a function of both engine speed and boost pressure or torque.

15. The engine system of claims 4, 5, or 6 further including an on-board knock sensor to select the hydrogen/gasoline ratio to prevent knock.

16. The engine system of claims 4, 5, or 6 wherein air/fuel mixture is stoichiometric over part or all of the operating range.

17. The engine system of claims 4, 5, or 6 further including apparatus to supply EGR to the engine over part or all of the operating range.

18. The engine system of claim 17 wherein a lean air/fuel mixture is used below a selected boost pressure or torque, and a stoichiometric or fuel rich air/fuel mixture is used above the selected boost pressure or torque.

19. The engine system of claims 4, 5, or 6 wherein a lean air/fuel mixture is used throughout all engine operating points in a drive cycle.

20. The engine system of claims 4, 5, or 6 further including apparatus to provide a desired spark retard above a selected boost pressure or torque to increase knock resistance, and the hydrogen/gasoline ratio is sufficient to allow greater spark retard than would be possible without hydrogen addition.

21. The engine system of claims 5 or 6 further including an on-board reformer for reforming gasoline into a hydrogen-rich gas for delivery to the engine.

22. The engine system of claim 21 wherein the amount of gasoline reformed by the reformer is controlled to establish the hydrogen-rich gas/gasoline ratio.

23. The engine system of claims 21 or 22 wherein the reformer is a plasmatron reformer.

24. The engine system of claim 4 wherein the source of hydrogen is provided by on-board hydrogen storage.

25. The engine system of claim 5 wherein the source of hydrogen-rich gas is provided by on-board hydrogen-rich gas storage.
